(19) United States
(12) Patent Application Publication
(10) Pub. No.: US 2024/0028375 A1
(43) Pub. Date: Jan. 25, 2024

(54) CONTROL PLANE LIFECYCLE MANAGEMENT WITH DPU DEVICES

(71) Applicant: VMWARE, INC., Palo Alto, CA (US)

(72) Inventors: PRADEEP SHANMUKHA JIGALUR, Bangalore (IN); CHRISTOPHER JOHN SCHAEFER, Venice, FL (US); BHAVANI CHINNAPURA RAJANNA, Bangalore (IN); DIVYA RANI, Santa Clara, CA (US); SUBHANI SHAIK, Bangalore (IN); ASTHA AGARWAL, Moradabad (IN); PRAKASH MISHRA, Bangalore (IN)

(21) Appl. No.: 17/979,019

(22) Filed: Nov. 2, 2022

(30) Foreign Application Priority Data
Jul. 21, 2022 (IN) 202241041844

(51) Int. Cl. G06F 9/455; G06F 8/65; G06F 8/61

(52) U.S. Cl. CPC G06F 9/45558; G06F 8/65; G06F 8/61; G06F 2009/4557; G06F 2009/45579

(57) ABSTRACT

Disclosed are various examples of control plane lifecycle management using data processing unit (DPU) devices. In some examples, a passthrough between a control plane virtual machine and a data processing unit (DPU) is enabled using a DPU management hypervisor executed by a DPU device. The DPU device is installed to the host device. The DPU device receives a control plane update command with instructions to update a control plane that includes the control plane virtual machine. The control plane update command is performed. Control plane data for the update is transmitted through the passthrough.

### RELATED APPLICATIONS

Benefit is claimed under 35 U.S.C. 119(a)-(d) to Foreign Application Serial No. 202241041844 filed in India entitled “CONTROL PLANE LIFECYCLE MANAGEMENT WITH DPU DEVICES”, on Jul. 21, 2022, by VMware, Inc., which is herein incorporated in its entirety by reference for all purposes.

### BACKGROUND

A service provider can maintain management services that are purchased and employed by various enterprises as customers of the service provider. Management services can use hypervisors for deploying and serving virtualization solutions that use hardware resources of a host device to provide virtual devices such as virtual machines. The management service can then deploy workloads to the virtual devices on behalf of an enterprise that employs the management service. The workloads can be executed using the hardware resources allocated to virtual devices and made available using the hypervisors installed on various host devices.

Data processing units (DPUs) can be physically installed to host devices. These DPUs can include processors, a network interface, and in many cases can include acceleration engines capable of machine learning, networking, storage, and artificial intelligence processing. The DPUs can include processing, networking, storage, and accelerator hardware.

In a Software as a Service (SaaS) model, the service provider is responsible for the lifecycle operations of the control plane. If lifecycle operations extend outside an agreed maintenance window according to a Service Level Agreement (SLA), the service provider can be subject to recourse defined in the SLA. With a SaaS supporting multiple customers, a small outage can have a large impact on the service provider. Lifecycle operations can take much longer than expected. One reason for extended downtime would be lifecycle operations involving the transfer of a large amount of related data. Network contention can cause a bottleneck for lifecycle operations on hosts that execute multiple workloads for the enterprise in addition to the control plane. There is a need for better mechanisms that can integrate DPUs into a virtualization and management solution to allay these issues.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment that includes components that enable control plane lifecycle management using a data processing unit (DPU) device, according to the present disclosure.

FIG. 2 is a drawing that provides an example of the operation of components of the networked environment of FIG. 1 for control plane lifecycle management using a DPU device, according to the present disclosure.

FIG. 3 is a flowchart illustrating functionality implemented by components of the networked environment of FIG. 1 for control plane lifecycle management using a DPU device, according to the present disclosure.

FIG. 4 is another flowchart illustrating functionality implemented by components of the networked environment of FIG. 1 for control plane lifecycle management using a DPU device, according to the present disclosure.

### DETAILED DESCRIPTION

The present disclosure relates to control plane lifecycle management using data processing unit (DPU) devices. The DPUs can be physically installed to host devices. The DPUs can include processors, a network interface, and in many cases can include acceleration engines capable of machine learning, networking, storage, and artificial intelligence processing. In a Software as a Service (SaaS) model, the service provider can be responsible for the lifecycle operations of the control plane. If lifecycle operations extend outside a maintenance window specified in a Service Level Agreement (SLA), the service provider can be subject to recourse defined in the SLA. Reasons for extended downtime can include lifecycle operations involving the transfer of a large amount of related data, such as data for an in-place update or a migration type update to a control plane virtual machine. Network contention during these updates can cause a bottleneck that delays lifecycle operations for the control plane. The present disclosure describes mechanisms that can enable control plane lifecycle management using data processing unit (DPU) devices. Specifically, the mechanisms can route control plane lifecycle management data through a DPU device 109, thereby avoiding networking bottleneck associated with a virtual switch of a hypervisor of a host device that executes a control plane virtual machine.

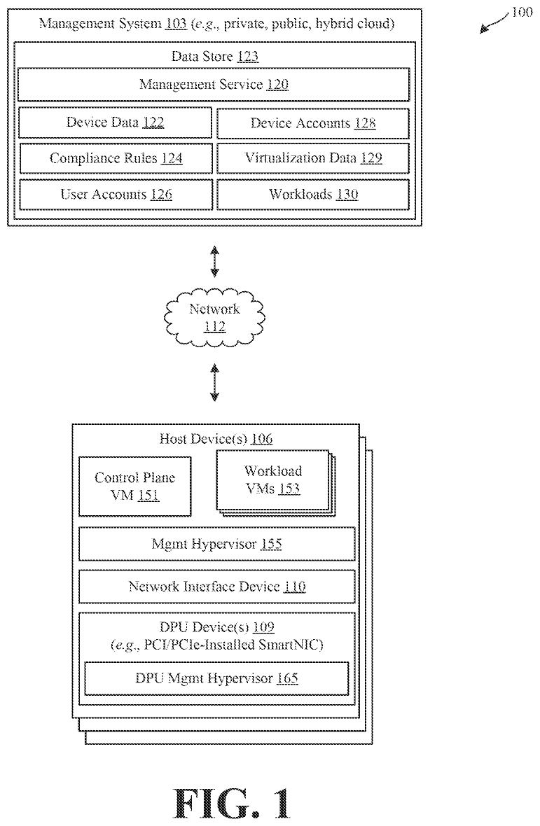

With reference to FIG. 1, shown is an example of a networked environment 100. The networked environment 100 can include a management system 103, host devices 106, and other components in communication with one another over a network 112. DPU devices 109 can be installed to the host devices 106. In some cases, host devices 106 can include computing devices or server computing devices of a private cloud, public cloud, hybrid cloud, and multi-cloud infrastructures. Hybrid cloud infrastructures can include public and private host computing devices. Multi-cloud infrastructures can include multiple different computing platforms from one or more service providers in order to perform a vast array of enterprise tasks.

The host devices 106 can also include devices that can connect to the network 112 directly or through an edge device or gateway. The components of the networked environment 100 can be utilized to provide virtualization solutions for one or more enterprises that employ the management service 120. The hardware of the host devices 106 can include physical memory, physical processors, physical data storage, and physical network resources that can be utilized by virtual machines. Host devices 106 can also include peripheral components such as the DPU devices 109. The host devices 106 can further include a network interface device 110 such as a standard ethernet card. The DPU device 109 and the network interface device 110 can be connected to respective bus connectors of the host device 106. The DPU device 109 and the network interface device 110 can also provide respective network connections to one or more networks 112. The network interface device 110 can include a standard network card that provides network connectivity for the host device. The network interface device 110 can be an integrated part of the host device 106 board, or can be connected to a bus interface connector.

The host devices 106 can include physical memory, physical processors, physical data storage, and physical network resources. Virtual memory, virtual processors, virtual data storage, and virtual network resources of a virtual machine can be mapped to physical memory, physical processors, physical data storage, and physical network resources of the host devices 106. The management hypervisor 155 can provide access to the physical memory, physical processors, physical data storage, and physical network resources of the host devices 106 to perform workloads 130.

The DPU devices 109 can include networking accelerator devices, smart network interface cards, or other cards that are installed as a peripheral component. The DPU devices 109 themselves can also include physical memory, physical processors, physical data storage, and physical network resources. The DPU devices 109 can also include specialized physical hardware that includes accelerator engines for machine learning, networking, storage, and artificial intelligence processing. Virtual memory, virtual processors, virtual data storage, and virtual network resources of a virtual machine can be mapped to physical memory, physical processors, physical data storage, physical network resources, and physical accelerator resources of the DPU devices 109. The DPU management hypervisor 165 can communicate with the management service 120 to provide access to the physical memory, physical processors, physical data storage, physical network resources, and physical accelerator resources of the DPU devices 109. The DPU management hypervisor 165 can also communicate with the management hypervisor 155 to provide a passthrough mechanism that can bypass a virtual switch of the management hypervisor 155. This can prevent networking bottleneck issues for control plane virtual machine 151 updates.

The control plane virtual machines 151 and workload virtual machines 153 can be used to execute various workloads 130. While referred to as virtual machines, these virtual machines can alternatively include containers and other virtualization components that execute the workloads 130. The workloads 130 can be managed by the management service 120 for an enterprise that employs the management service 120. Some workloads 130 can be initiated and accessed by enterprise users through client devices. For example, the workloads 130 can include enterprise workloads 130 that are used to provide access to enterprise applications, services, data, and other enterprise resources. Enterprise workloads 130 can be executed using workload virtual machines 153, which can also be referred to as enterprise workload virtual machines 153.

The workloads 130 can also include control plane workloads 130. The control plane workloads 130 can be workloads 130 that execute applications and services that enable the management service 120 to support virtualization functions. These workloads 130 can control signaling traffic between various components. Control plane or service provider workloads 130 can be executed using control plane virtual machines 151. Control plane virtual machines 151 and related workloads 130 do not participate in the flow of enterprise customer level or user level traffic and do not generally generate a high networking load. However, the networking load of the workload virtual machines 153 can cause a bottleneck that can delay control plane lifecycle updates in existing technologies. By contrast, the mechanisms described herein can use a DPU device 109 to bypass the virtual switch of the management hypervisor 155 to avoid the bottlenecking issue.

The virtualization data 129 can include a record of the virtual devices, as well as the host devices 106 and DPU devices 109 that are mapped to the virtual devices, including the control plane virtual machines 151 and workload virtual machines 153. The virtualization data 129 can also include a record of the workloads 130 that are executed by the virtual devices.

The network 112 can include the Internet, intranets, extranets, wide area networks (WANs), local area networks (LANs), wired networks, wireless networks, other suitable networks, or any combination of two or more such networks. The networks can include satellite networks, cable networks, Ethernet networks, telephony networks, and other types of networks.

The management system 103 can include one or more host or server computers, and any other system providing computing capability. In some examples, a subset of the host devices 106 can provide the hardware for the management system 103. While referred to in the singular, the management system 103 can include a plurality of computing devices that are arranged in one or more server banks, computer banks, or other arrangements. The management system 103 can include a grid computing resource or any other distributed computing arrangement. The management system 103 can be multi-tenant, providing virtualization and management of workloads 130 for multiple different enterprises. Alternatively, the management system 103 can be customer or enterprise-specific.

The computing devices of the management system 103 can be located in a single installation or can be distributed among many different geographical locations which can be local and/or remote from the other components. The management system 103 can also include or be operated as one or more virtualized computer instances. For purposes of convenience, the management system 103 is referred to herein in the singular. Even though the management system 103 is referred to in the singular, it is understood that a plurality of management systems 103 can be employed in the various arrangements as described above.

The components executed on the management system 103 can include a management service 120, as well as other applications, services, processes, systems, engines, or functionality not discussed in detail herein. The management service 120 can be stored in the data store 123 of the management system 103. While referred to generally as the management service 120 herein, the various functionalities and operations discussed can be provided using a management service 120 that includes a scheduling service and a number of software components that operate in concert to provide compute, memory, network, and data storage for enterprise workloads and data. The management service 120 can also provide access to the enterprise workloads and data executed by the host devices 106 and can be accessed using client devices that can be enrolled in association with a user account 126 and related credentials.

The management service 120 can communicate with associated management instructions executed by host devices 106, client devices, edge devices, and IoT devices to ensure that these devices comply with their respective compliance rules 124, whether the specific host device 106 is used for computational or access purposes. If the host devices 106 or client devices fail to comply with the compliance rules 124, the respective management instructions can perform remedial actions including discontinuing access to and processing of workloads 130.

The data store 123 can include any storage device or medium that can contain, store, or maintain the instructions, logic, or applications described herein for use by or in connection with the instruction execution system. The data store 123 can be a hard drive or disk of a host, server computer, or any other system providing storage capability. While referred to in the singular, the data store 123 can include a plurality of storage devices that are arranged in one or more hosts, server banks, computer banks, or other arrangements. The data store 123 can include any one of many physical media, such as magnetic, optical, or semiconductor media. More specific examples include solid-state drives or flash drives. The data store 123 can include a data store 123 of the management system 103, mass storage resources of the management system 103, or any other storage resources on which data can be stored by the management system 103. The data store 123 can also include memories such as RAM used by the management system 103. The RAM can include static RAM (SRAM), dynamic RAM (DRAM), synchronous DRAM (SDRAM), and other types of RAM.

The data stored in the data store 123 can include management data including device data 122, enterprise data, compliance rules 124, user accounts 126, and device accounts 128, as well as other data. Device data 122 can identify host devices 106 by one or more device identifiers, a unique device identifier (UDID), a media access control (MAC) address, an internet protocol (IP) address, or another identifier that uniquely identifies a device with respect to other devices.

The device data 122 can include an enrollment status indicating whether each computing device is enrolled with or managed by the management service 120. For example, an end-user device, an edge device, IoT device, host device 106, DPU device 109, client device, and other devices can be designated as “enrolled” and can be permitted to access the enterprise workloads and data hosted by host devices 106, while those designated as “not enrolled,” or having no designation, can be denied access to the enterprise resources. The device data 122 can further include indications of the state of IoT devices, edge devices, end user devices, the host device 106, the DPU device 109 and other devices. While a user account 126 can be associated with a particular person as well as client devices, a device account 128 can be unassociated with any particular person, and can nevertheless be utilized for an IoT device, edge device, or another client device that provides automatic functionalities.

Device data 122 can also include data pertaining to user groups. An administrator can specify one or more of the host devices 106 as belonging to a user group. The user group can refer to a group of user accounts 126, which can include device accounts 128. User groups can be created by an administrator of the management service 120.

Compliance rules 124 can include, for example, configurable criteria that must be satisfied for the host devices 106 and other devices to be in compliance with the management service 120. The compliance rules 124 can be based on a number of factors, including geographical location, activation status, enrollment status, and authentication data, including authentication data obtained by a device registration system, time, and date, and network properties, among other factors associated with each device. The compliance rules 124 can also be determined based on a user account 126 associated with a user.

Compliance rules 124 can include predefined constraints that must be met in order for the management service 120, or other applications, to permit host devices 106 and other devices access to enterprise data and other functions of the management service 120. The management service 120 can communicate with management instructions on the client device to determine whether states exist on the client device which do not satisfy one or more of the compliance rules 124. States can include, for example, a virus or malware being detected; installation or execution of a blacklisted application; and/or a device being “rooted” or “jailbroken,” where root access is provided to a user of the device. Additional states can include the presence of particular files, questionable device configurations, vulnerable versions of applications, vulnerable states of the client devices or other vulnerability, as can be appreciated. While the client devices can be discussed as user devices that access or initiate workloads 130 that are executed by the host devices 106, all types of devices discussed herein can also execute virtualization components and provide hardware used to host workloads 130.

The management service 120 can oversee the management and resource scheduling using hardware provided using host devices 106. The management service 120 can transmit various software components, including enterprise workloads, enterprise data, and other enterprise resources for processing and storage using the various host devices 106. The host devices 106 can include host devices 106 such as a server computer or any other system providing computing capability, including those that compose the management system 103. Host devices 106 can include public, private, hybrid cloud and multi-cloud devices that are operated by third parties with respect to the management service 120. The host devices 106 can be located in a single installation or can be distributed among many different geographical locations which can be local and/or remote from the other components.

The host devices 106 can include DPU devices 109 that are connected to the host device 106 through a universal serial bus (USB) connection, a Peripheral Component Interconnect Express (PCI-e) or mini-PCI-e connection, or another physical connection. DPU devices 109 can include hardware accelerator devices specialized to perform artificial neural networks, machine vision, machine learning, and other types of special purpose instructions written using CUDA, OpenCL, C++, and other instructions. The DPU devices 109 can utilize in-memory processing, low-precision arithmetic, and other types of techniques. The DPU devices 109 can have hardware including a network interface controller (NIC), CPUs, data storage devices, memory devices, and accelerator devices.

The management service 120 can include a scheduling service that monitors resource usage of the host devices 106, and particularly the host devices 106 that execute enterprise workloads 130. The management service 120 can also track resource usage of DPU devices 109 that are installed on the host devices 106. The management service 120 can track the resource usage of DPU devices 109 in association with the host devices 106 to which they are installed. The management service 120 can also track the resource usage of DPU devices 109 separately from the host devices 106 to which they are installed.

In some examples, the DPU devices 109 can execute workloads 130 assigned to execute on host devices 106 to which they are installed. This can include the control plane virtual machine 151. However, in other examples, the control plane virtual machine 151 can be executed using hardware resources of the host device 106 rather than those of the connected DPU device 109. In some examples, the management hypervisor 155 can communicate with a DPU management hypervisor 165 to offload all or a subset of a particular workload 130 to be performed using the hardware resources of a DPU device 109. Alternatively, the DPU devices 109 can execute workloads 130 assigned specifically to the DPU device 109 or to a virtual device that includes the hardware resources of a DPU device 109. In some examples, the management service 120 can communicate directly with the DPU management hypervisor 165, and in other examples the management service 120 can use the management hypervisor 155 to communicate with the DPU management hypervisor 165.

The host device 106 can include additional management components that work in concert with the management hypervisor 155 to enable virtualization and other functions of the management service 120. The management components can communicate with the management service 120 for scheduling of workloads 130 executed using virtual resources that are mapped to the physical resources of one or more host device 106. The management component can communicate with the management hypervisor 155 to deploy virtual devices that perform the workloads 130. In various embodiments, the management component can be separate from, or a component of, the management hypervisor 155.

Likewise, the DPU device 109 can include additional management components that work in concert with the DPU management hypervisor 165 to enable virtualization and other functions of the management service 120. The management components can communicate with the management service 120 for scheduling of workloads 130 executed using virtual resources that are mapped to the physical resources the host device 106 and/or the DPU device 109. The management component can communicate with the DPU management hypervisor 165 to deploy virtual devices that perform the workloads 130. In various embodiments, the management component can be separate from, or a component of, the DPU management hypervisor 165. The DPU management hypervisor 165 and the management hypervisor 155 can work in concert to provide a passthrough functionality such as a Single Root Input/Output (I/O) Virtualization (SR-IOV) functionality that enables the control plane virtual machine 151 to communicate with the managements service 120 and other network services through the DPU device 109 rather than the network interface device 110. The passthrough functionality can bypass the management hypervisor's 155 virtual switch, which handles network data for enterprise workload virtual machines 153.

The management hypervisor 155 can include a bare metal or type 1 hypervisor that can provide access to the physical memory, physical processors, physical data storage, and physical network resources of the host devices 106 to perform workloads 130. A management hypervisor 155 can create, configure, reconfigure, and remove virtual machines and other virtual devices on a host device 106. The management hypervisor 155 can also relay instructions from the management service 120 to the DPU management hypervisor 165, and vice versa. The management service 120 can also communicate with the DPU management hypervisor 165 directly.

The DPU device 109 can include the DPU management hypervisor 165. The DPU management hypervisor 165 can be a management-service-specific operating system that enables the management service 120 to manage the DPU device 109 and assign workloads 130 to execute using its resources. The DPU management hypervisor 165 can communicate with the management hypervisor 155 and/or with the management service 120 directly to provide access to the physical memory, physical processors, physical data storage, physical network resources, and physical accelerator resources of the DPU devices 109.

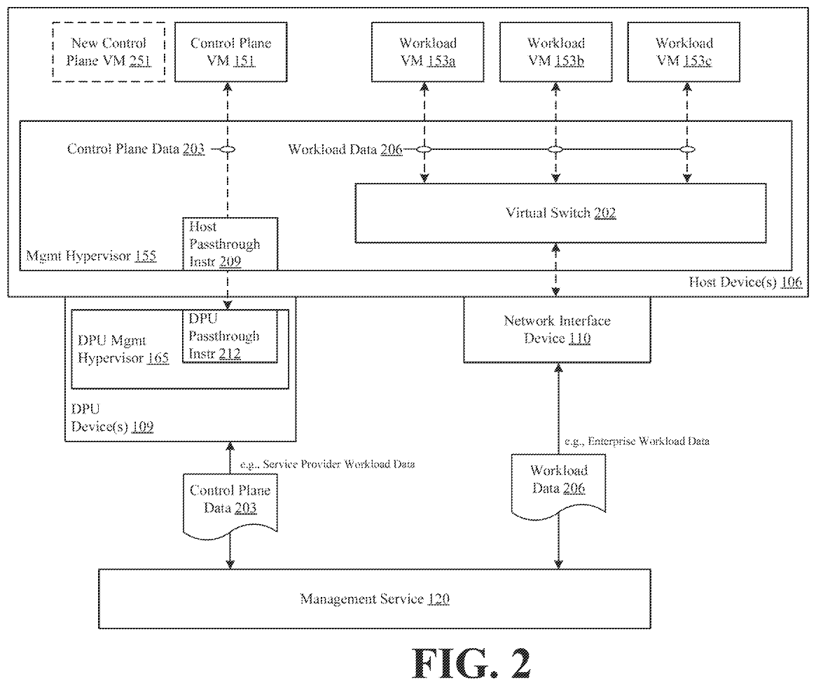

FIG. 2 is a drawing that provides an example of the operation of components of the networked environment 100 for control plane lifecycle management using a DPU device 109. This figure shows a control plane virtual machine 151, as well as workload virtual machines 153a-153c. These virtual machines can be launched using the management hypervisor 155 and/or the DPU management hypervisor 165.

The management hypervisor 155 can generate a virtual switch 202 using the kernel instructions of the management hypervisor 155. Generally and by default, all virtual machines that are launched by the management hypervisor 155 use the virtual switch 202 to communicate upstream and downstream network traffic. The management hypervisor 155 can associate the virtual switch 202 with the network interface device 110. The virtual switch 202 can transmit and receive the network data through the network interface device 110.

The management hypervisor 155 can launch the control plane virtual machine 151, as well as workload virtual machines 153a-153c, using hardware resources of the host device 106. Since all of these workloads can use the virtual switch 202, there can be a bottleneck if the bandwidth of the workload virtual machines 153a-153c exceeds or comes within a threshold value from the bandwidth of the network interface device 110. However, a DPU device 109 can be installed to the host device 106 to provide dedicated network connectivity to the control plane virtual machine 151.

The DPU management hypervisor 165 and the management hypervisor 155 can work in concert to enable the control plane virtual machine 151 to communicate through a network connection of the DPU device 109, rather than through the network interface device 110. The management hypervisor 155 can include “host” passthrough instructions 209, and the DPU management hypervisor 165 can include “DPU” passthrough instructions 212. The host passthrough instructions 209 and the DPU passthrough instructions 212 can create a passthrough such as a single root I/O virtualization (SR-IOV) passthrough or a PCIe passthrough connection between the control plane virtual machine 151 and the DPU device 109.

The passthrough can route the control plane data 203 between the control plane virtual machine 151 and the DPU device 109 through a path that avoids the virtual switch 202. The workload data 206 for all of the workload virtual machines 153a-153c can be routed through the virtual switch 202.

The control plane data 203 can include control plane virtual machine 151 updates. This can include update instructions as well as data defining an in-place software update or a replacement virtual machine for a migration update. For example, the control plane data 203 can include instructions to download and install a software update that is installed in place of the control plane virtual machine 151. The control plane data 203 can also include instructions to launch a new control plane virtual machine 251 as a replacement, switch control plane operations to the new control plane virtual machine 251, and delete the previous control plane virtual machine 151 once control is transferred. The DPU management hypervisor 165 and the management hypervisor 155 can work in concert to enable passthrough mode for the new control plane virtual machine 251 as well as the data that is transferred in order to launch the new control plane virtual machine 251.

Software components of the control plane virtual machine 151 can perform the instructions to perform an in-place update by downloading and installing a software update. The software update can be downloaded from a network endpoint specified by the update instructions. The network endpoint can be an endpoint of the management service 120 or another network service. The data of the software update, requests to retrieve the software update, and other data that can be routed through the passthrough rather than through the standard virtual switch 202 of the management hypervisor 155.

Software components of the DPU management hypervisor 165 and the management hypervisor 155 can perform a migration update using a new control plane virtual machine 251. For example, the DPU management hypervisor 165 can launch the new control plane virtual machine 251 using hardware of the host device 106, or can relay instructions such that the management hypervisor 155 launches the new control plane virtual machine 251 using hardware of the host device 106. The DPU management hypervisor 165 can also work in concert with the management hypervisor 155 to transfer control to the new control plane virtual machine 251, halt the control plane virtual machine 151, and remove the control plane virtual machine 151. Using a migration type update can minimize control plane downtime, and using the passthrough between the control plane virtual machine 151 and the DPU device 109 can further prevent delays and downtime.

Alternatively, the control plane virtual machine 151 and the new control plane virtual machine 251 can be executed using hardware resources of the DPU device 109. In either scenario, the DPU management hypervisor 165 can enable a passthrough such as an SR-IOV passthrough between the DPU device 109 and the new control plane virtual machine 251.

The management service 120 can transmit all or a portion of the control plane data 203 through an endpoint of the DPU device 109. For example, the management service 120 can transmit the initial instructions. Additional control plane data 203 such as the software update or the data defining the new control plane virtual machine 251 can be downloaded from the management service 120 or another source. On the other hand, the workload data 206 can be transmitted through an endpoint of the network interface device 110 of the host device 106.

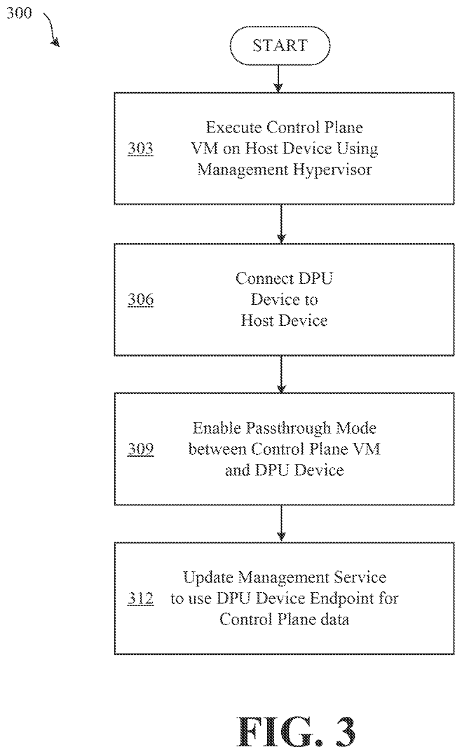

FIG. 3 shows a flowchart 300 that illustrates functionality implemented by components of the networked environment 100 for control plane lifecycle management. The flowchart 300 generally shows how the components of the networked environment 100 can provide a passthrough between the control plane virtual machine 151 and the DPU device 109 for lifecycle operations. While steps can refer to a particular device or component, certain aspects of the steps can be performed by other components as can be understood.

In step 303, the management hypervisor 155 can launch the control plane virtual machine 151 using hardware resources of the host device 106. The management hypervisor 155 can virtualize resources of the host device 106, and can use these resources for the control plane virtual machine 151. In other words, the control plane virtual machine 151 can be executed on the host device 106.

In step 306, the host device 106 can have a DPU device 109 connected. The DPU device 109 can be a removable device that can be connected to the host device 106 through a bus interface connector. An information technology specialist can perform the installation, or the DPU device 109 can be preinstalled to the host device 106.

In step 309, the DPU device 109 can execute the DPU management hypervisor 165. The DPU management hypervisor 165 can enable a passthrough mode between the control plane virtual machine 151 and the DPU device 109 network connection. For example, the DPU management hypervisor 165 can include DPU passthrough instructions 212 that enable the passthrough mode. The DPU passthrough instructions 212 can work in concert with the host passthrough instructions 209 of the management hypervisor 155 to provide the passthrough between the control plane virtual machine 151 and the DPU device 109 network connection.

The passthrough mode can route all control plane data 203 through the DPU device 109 and using a path that avoids the virtual switch 202. The control plane data 203 can include update data and other communications for workloads 130 of the service provider of the management service 120. On the other hand, the workload data 206 can be routed through the network interface device 110 and through the virtual switch 202 of the management hypervisor 155. The workload data 206 can include data for enterprise workloads of an enterprise that employs the management service 120. This can prevent network usage of workload virtual machines 153 from delaying control plane virtual machine 151 updates and other lifecycle operations.

In step 312, once the passthrough mode is enabled, the management service 120 can be updated to use an endpoint provided using the DPU device 109 for control plane data 203. The DPU device 109 can be associated with a different public or private network address than the network interface device 110. As a result, the public or private network address used for the control plane data 203 can be updated in the management service 120 once the passthrough mode is enabled. In other examples, other components of the networked environment can appropriately route control plane data 203 through the DPU device 109 once the passthrough mode is enabled. The passthrough can dedicate a service provider's control plane data 203 through a separate networking route other than an enterprise's workload data 206. The passthrough can be routed to avoid the virtual switch 202 of the management hypervisor 155 as well as the network interface device 110.

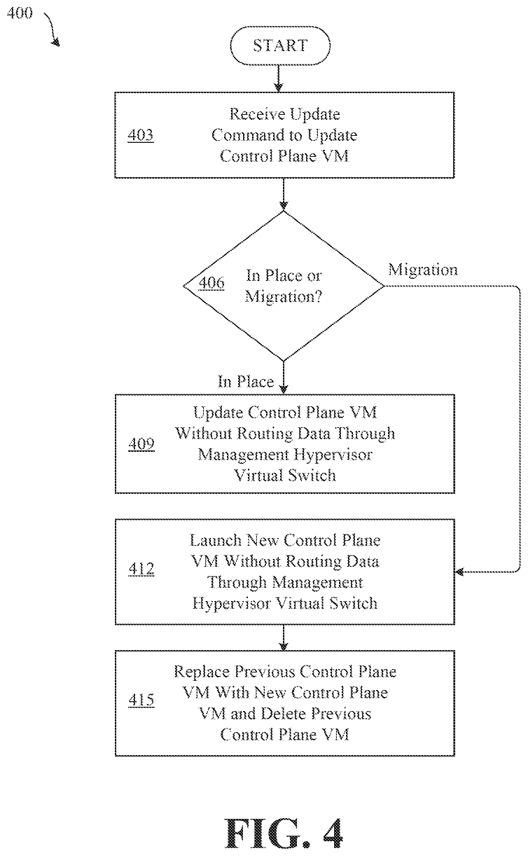

FIG. 4 shows a flowchart 400 that illustrates functionality implemented by components of the networked environment 100 for control plane lifecycle management. The flowchart 400 generally shows how the components of the networked environment 100 can use the passthrough between the control plane virtual machine 151 and the DPU device 109 for lifecycle operations. The flowchart 400 considers a scenario where the passthrough between the DPU device 109 and the control plane virtual machine 151 has been established, for example, according to the steps of the flowchart 300. While steps can refer to a particular device or component, certain aspects of the steps can be performed by other components as can be understood.

In step 403, the DPU device 109 can receive control plane data 203 that includes an update command to update a control plane virtual machine 151. The management service 120 and other components of the networked environment 100 can route control plane data 203 to the DPU device 109. This can minimize control plane management time relative to other technologies by avoiding a bottleneck at the network interface device 110 connection as well as internally at the virtual switch 202 of the management hypervisor 155.

In step 406, the flow can differ depending on whether the update command includes an update for an in-place update or a migration update. The DPU management hypervisor 165 can determine whether the update command includes an update for an in-place update or a migration update. If the update command specifies an in-place update, then the process can move to step 409. If the update command specifies a migration update, the process can move to step 412. In either case, the portion of the control plane data 203 that is passed to the control plane virtual machine 151 can be transmitted through a passthrough such as an SR-IOV passthrough or a PCIe passthrough.

In step 409, the control plane virtual machine 151 can receive the control plane data 203 through the passthrough rather than routing the control plane data 203 through the virtual switch 202. The control plane virtual machine 151 can perform the in-place update by downloading and installing a software update. The control plane virtual machine 151 can download a software update from a network endpoint specified by the update instructions. The network endpoint can be an endpoint of the management service 120 or another network service. The data of the software update, requests to retrieve the software update, and other data can be routed through the passthrough rather than through the standard virtual switch 202 of the management hypervisor 155.

In some examples, the DPU management hypervisor 165 can transmit the control plane data 203 through the passthrough directly. The DPU management hypervisor 165 can also cause the control plane virtual machine 151 to install an update once downloaded by the DPU management hypervisor 165. Alternatively, the DPU management hypervisor 165 can instruct the management hypervisor 155 to cause the control plane virtual machine 151 to install an update downloaded by either the management hypervisor 155 or the DPU management hypervisor 165.

In step 412, the DPU management hypervisor 165 can launch a new control plane virtual machine 251, without routing data through the virtual switch 202 of the management hypervisor 155. The DPU management hypervisor 165 and the management hypervisor 155 can also work in concert to perform the migration update. In the various embodiments, the DPU management hypervisor 165 can launch the new control plane virtual machine 251 using hardware of the host device 106, or can relay instructions such that the management hypervisor 155 launches the new control plane virtual machine 251 using hardware of the host device 106. The data that defines the new control plane virtual machine 251 is downloaded and routed through the passthrough rather than through the virtual switch 202 of the management hypervisor 155. The management hypervisor 155 or the DPU management hypervisor 165 can perform the download according to the control plane data 203.

In step 415, the DPU management hypervisor 165 can replace the previous control plane virtual machine 151 with the new control plane virtual machine 251, and delete the previous control plane virtual machine 151. The DPU management hypervisor 165 can work in concert with the management hypervisor 155 to transfer control from the control plane virtual machine 151 to the new control plane virtual machine 251. The DPU management hypervisor 165 can work in concert with the management hypervisor 155 to halt the control plane virtual machine 151 and remove or delete it from the host device 106 or the DPU device 109.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory devices can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the various services and functions described herein can be embodied in software or code executed by general purpose hardware as discussed above, as an alternative, the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagrams and flowcharts can show examples of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or another system. The machine code can be converted from the source code. If embodied in hardware, each block can represent a circuit or a number of interconnected circuits to implement the specified logical function(s).

Although sequence diagrams and flowcharts can be shown in a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described herein that includes software or code can be embodied in any non-transitory computer-readable medium for use by or in connection with an instruction execution system such as a processor in a computer system or another system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described embodiments of the present disclosure are merely possible examples of implementations described for a clear understanding of the principles of the disclosure. Many variations and modifications can be made to the above-described embodiments without departing substantially from the spirit and principles of the disclosure. All such modifications and variations are intended to be included in the following claims herein, within the scope of this disclosure.

What is claimed is:

1. A non-transitory computer-readable medium comprising executable instructions, wherein the instructions, when executed by at least one processor, cause at least one computing device to at least:
enable a passthrough between a control plane virtual machine and a data processing unit (DPU), the passthrough being enabled using a DPU management hypervisor executed by a DPU device, wherein the DPU device is installed to a host device;
receive, through the DPU device, a control plane update command comprising instructions to update a control plane comprising the control plane virtual machine; and
perform the control plane update command, wherein control plane data that is used to implement the control plane update command is transmitted through the passthrough.

2. The non-transitory computer-readable medium of claim 1, wherein the passthrough is enabled using the DPU management hypervisor of the DPU device and a management hypervisor executed by the host device.

3. The non-transitory computer-readable medium of claim 2, wherein the passthrough routes the control plane data around a virtual switch of the management hypervisor.

4. The non-transitory computer-readable medium of claim 1, wherein the passthrough comprises a single root I/O virtualization (SR-IOV) passthrough.

5. The non-transitory computer-readable medium of claim 1, wherein the control plane update command comprises an in-place update command for the control plane virtual machine to install a software update for at least one component of the control plane virtual machine.

6. The non-transitory computer-readable medium of claim 1, wherein the control plane update command comprises a migration update command to replace the control plane virtual machine with an updated control plane virtual machine.

7. The non-transitory computer-readable medium of claim 6, wherein the instructions, when executed by the at least one processor, cause the at least one computing device to perform the migration update command by actions that at least:
launch the updated control plane virtual machine, wherein data comprising the updated control plane virtual machine is routed using the passthrough; and
delete the control plane virtual machine once control is transferred to the updated control plane virtual machine.

8. A system, comprising:
at least one computing device comprising at least one processor; and
a data store comprising executable instructions, wherein the instructions, when executed by the at least one processor, cause the at least one computing device to at least:
enable a passthrough between a control plane virtual machine and a data processing unit (DPU), the passthrough being enabled using a DPU management hypervisor executed by a DPU device, wherein the DPU device is installed to a host device;
receive, through the DPU device, a control plane update command comprising instructions to update a control plane comprising the control plane virtual machine; and
perform the control plane update command, wherein control plane data that is used to implement the control plane update command is transmitted through the passthrough.

9. The system of claim 8, wherein the passthrough is enabled using the DPU management hypervisor of the DPU device and a management hypervisor executed by the host device.

10. The system of claim 9, wherein the passthrough routes the control plane data around a virtual switch of the management hypervisor.

11. The system of claim 8, wherein the passthrough comprises a single root I/O virtualization (SR-IOV) passthrough.

12. The system of claim 8, wherein the control plane update command comprises an in-place update command for the control plane virtual machine to install a software update for at least one component of the control plane virtual machine.

13. The system of claim 8, wherein the control plane update command comprises a migration update command to replace the control plane virtual machine with an updated control plane virtual machine.

14. The system of claim 13, wherein the instructions, when executed by the at least one processor, cause the at least one computing device to perform the migration update command by actions that at least:
launch the updated control plane virtual machine, wherein data comprising the updated control plane virtual machine is routed using the passthrough; and
delete the control plane virtual machine once control is transferred to the updated control plane virtual machine.

15. A method, comprising:
enabling a passthrough between a control plane virtual machine and a data processing unit (DPU), the passthrough being enabled using a DPU management hypervisor executed by a DPU device, wherein the DPU device is installed to a host device;
receiving, through the DPU device, a control plane update command comprising instructions to update a control plane comprising the control plane virtual machine; and
performing the control plane update command, wherein control plane data that is used to implement the control plane update command is transmitted through the passthrough.

16. The method of claim 15, wherein the passthrough is enabled using the DPU management hypervisor of the DPU device and a management hypervisor executed by the host device.

17. The method of claim 16, wherein the passthrough routes the control plane data around a virtual switch of the management hypervisor.

18. The method of claim 15, wherein the passthrough comprises a single root I/O virtualization (SR-IOV) passthrough.

19. The method of claim 15, wherein the control plane update command comprises an in-place update command for the control plane virtual machine to install a software update for at least one component of the control plane virtual machine.

20. The method of claim 15, wherein the control plane update command comprises a migration update command to replace the control plane virtual machine with an updated control plane virtual machine.
